(19) United States
(12) Patent Application Publication
(10) Pub. No.: US 2006/0234571 A1
(43) Pub. Date: Oct. 19, 2006

(54) Indicator whether clothing has received proper care

(75) Inventor: Zvi Shamir, Tel Aviv (IL)

Correspondence Address: DARBY & DARBY P.C., P. O. BOX 5257, NEW YORK, NY, 10150-5257, US

(73) Assignee: BAGIR CO., Kiryat Gat (IL)

(21) Appl. No.: 10/540,295

(22) PCT Filed: Dec. 10, 2003
(86) PCT No.: PCT/IL03/01052

§ 371 Date: Nov. 18, 2005

Related U.S. Application Data
(60) Provisional application No. 60/434,276, filed on Dec. 18, 2002.

(51) Int. Cl. B32B 3/00; B32B 5/02; B32B 9/00

(52) U.S. Cl. 442/59; 428/913; 283/72; 283/81; 283/100

(57) ABSTRACT

An article of clothing bearing an indicator, which indicates whether it has been washed in water.

### REFERENCE TO CO-PENDING APPLICATIONS

Applicant hereby claims priority of U.S. Provisional Patent Application Serial No. 60/434,276, entitled “INDICATOR WHETHER CLOTHING HAS RECEIVED PROPER CARE”, filed Dec. 18, 2002.

### FIELD OF THE INVENTION

The present invention relates to clothing and to indications that clothing has received proper care.

### BACKGROUND OF THE INVENTION

With increased sophistication and diversification in the manufacture of clothing and fabrics, proper care of the clothing by the consumer is of increasing importance. Guarantees offered by the manufacturer as to the quality of clothing are, of necessity, predicated on proper care thereof by the consumer.

A commonly occurring example relates to articles of clothing which require dry cleaning as opposed to washing in water.

When a consumer seeks to return an article of clothing and invokes a quality issue, it is desirable to enable a sales clerk to readily determine whether the article of clothing has been properly cared for.

### SUMMARY OF THE INVENTION

The present invention seeks to provide apparatus and techniques for ascertaining and readily demonstrating that an article of clothing has not been properly cared for.

There is thus provided in accordance with a preferred embodiment of the present invention an article of clothing bearing an indicator, which indicates whether it has been washed in water.

In accordance with a preferred embodiment of the present invention, the indicator includes a label normally attached to the clothing. Alternatively, the indicator forms an integral part of the article of clothing.

Preferably, the indicator changes its state when it has been washed in water. Alternatively, the indicator disassociates as the result of prolonged exposure to water. Alternatively or additionally, the indicator changes color as the result of washing in water.

In accordance with another preferred embodiment, the indicator includes a legend stating that it has been exposed to water and a water soluble cover, which covers the legend until the cover has been exposed to water. Additionally or alternatively, the indicator includes at least one water soluble adhesive.

There is also provided in accordance with another preferred embodiment of the present invention an indicator useful with an article of clothing for indicating whether the article of clothing has been washed in water.

### BRIEF DESCRIPTION OF THE DRAWINGS

The present invention will be understood and appreciated more fully from the following detailed description, taken in conjunction with the drawing in which:

FIG. 1 illustrates a scenario in accordance with a preferred embodiment of the present invention in which an article of clothing, having a DRY CLEAN ONLY care label, is purchased in good condition, washed in water and then sought to be returned, wherein an indicator on the article of clothing indicates to a sales clerk that the article of clothing has been washed;

FIGS. 2A and 2B illustrate a multi-layer care label constructed and operative in accordance with a preferred embodiment of the present invention in non-washed and post washed states;

FIGS. 3A and 3B illustrate a multi-layer indicator constructed and operative in accordance with another preferred embodiment of the present invention in non-washed and post washed states;

FIGS. 4A and 4B illustrate an article of clothing constructed and operative in accordance with a preferred embodiment of the present invention, including an integrally formed portion bearing an indicator which clearly indicates washing, in non-washed and post washed states; and

FIGS. 5A and 5B illustrate an article of clothing constructed and operative in accordance with another preferred embodiment of the present invention, including an integrally formed portion which changes color to clearly indicate washing, in non-washed and post washed states.

### DETAILED DESCRIPTION OF PREFERRED EMBODIMENTS

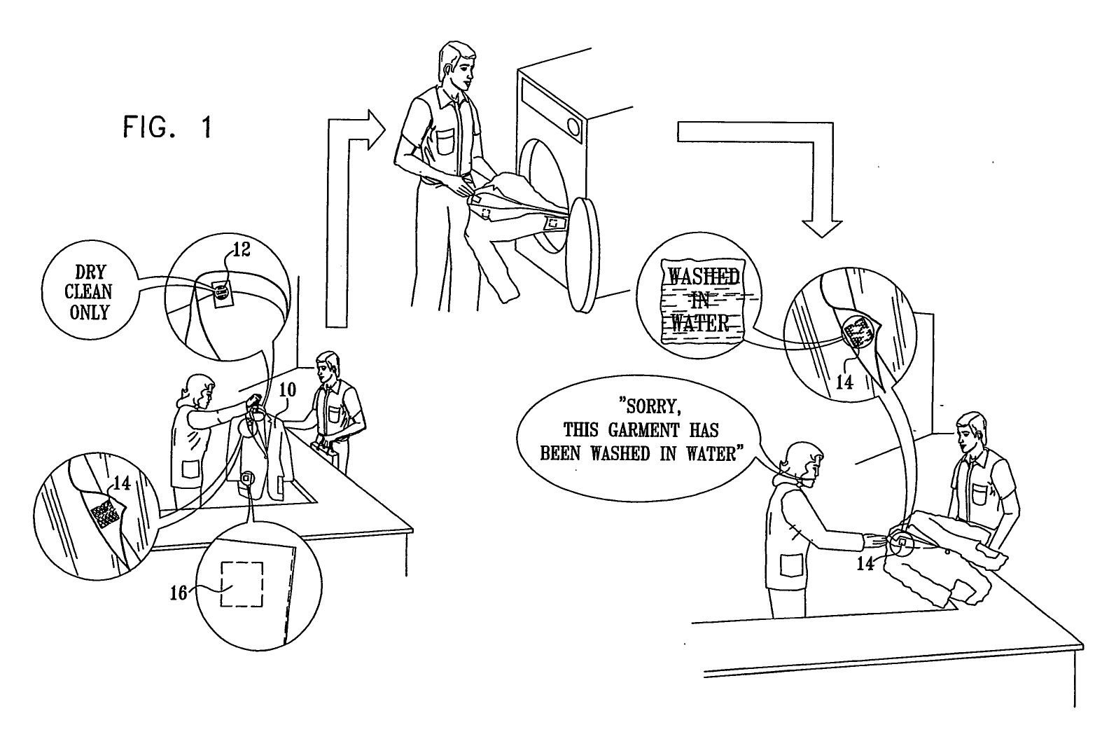

Reference is now made to FIG. 1, which illustrates a scenario in accordance with a preferred embodiment of the present invention in which an article of clothing, having a DRY CLEAN ONLY care label, is purchased in good condition, washed in water and then sought to be returned, where in an indicator on the article of clothing indicates to a sales clerk that the article of clothing has been washed.

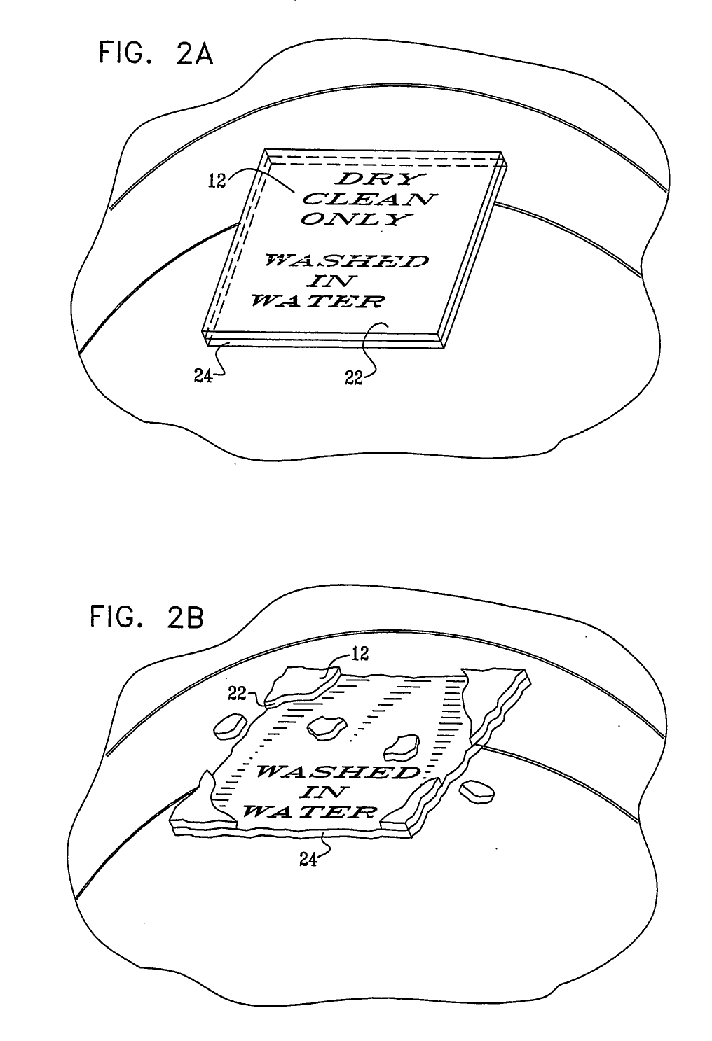

In the illustrated embodiment of FIG. 1, the article of clothing, here a jacket 10, includes one or more washing indicators, typically an indicator 12 in the form of a care label constructed and operative in accordance with a preferred embodiment of the present invention, which bears conventional care information such as DRY CLEAN ONLY. Indicator 12 is preferably of the type described hereinbelow and illustrated in FIGS. 2A and 2B.

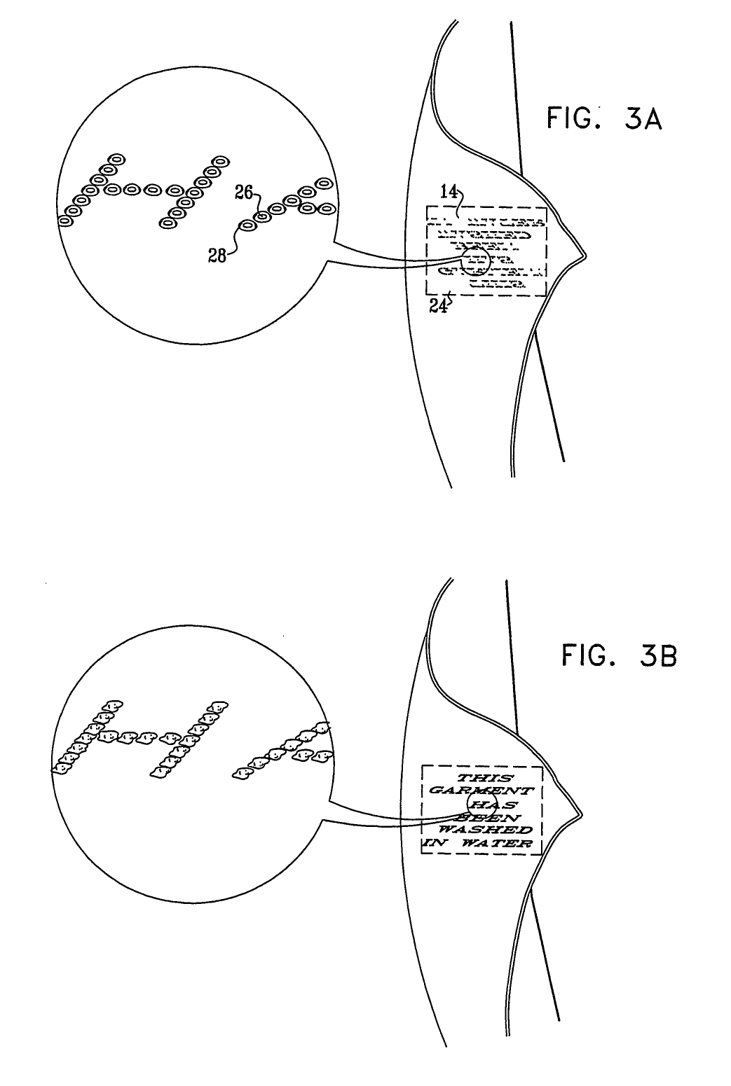

Jacket 10 may also include another indicator 14, typically located under the jacket lapel, which normally does not carry any message. Indicator 14 is preferably of the type described hereinbelow and illustrated in FIGS. 3A and 3B.

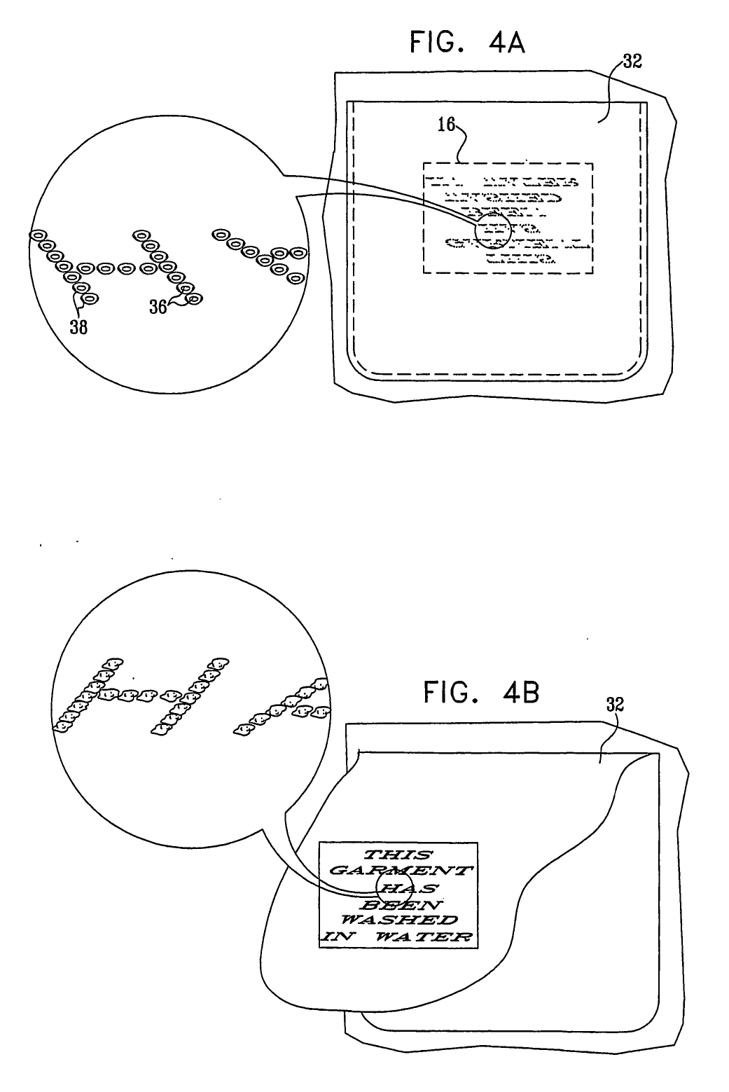

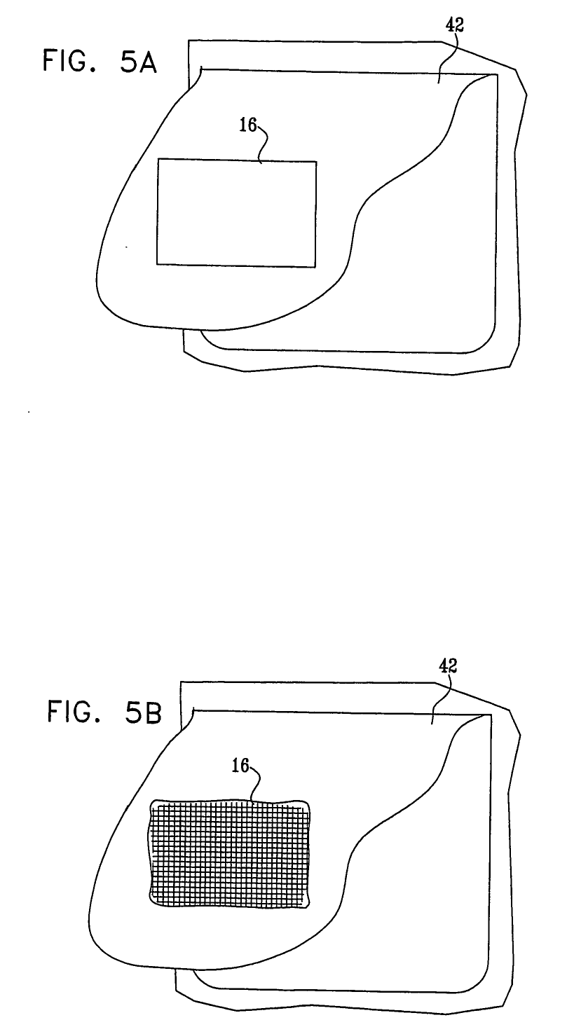

Additionally, jacket 10 may incorporate an indicator 16 integrally formed therewith, such as a pocket liner, all or part of which changes its color when washed. Indicator 16 is preferably one of the types described hereinbelow and illustrated in FIGS. 4A-5B.

It is appreciated that although a jacket is illustrated in FIG. 1, the present invention is applicable to any suitable article of clothing. It is further appreciated that any one or more suitable indicators may be employed as appropriate to any article of clothing. The examples described hereinabove and illustrated in FIGS. 2A-5B are not to be taken as limiting the type or location of washing indicators that may be employed.

As seen in FIG. 1, the presence of indicators 12, 14 and 16 does not change the appearance or utility of the jacket. However, when the jacket is washed in water, a change takes place in the indicators 12, 14 and 16, providing a visually sensible indication that washing in water has occurred. When the washed article of clothing is returned for a refund, the sales clerk examines one or more of the indicators 10, 12 and 14 and clearly sees an unambiguous indication that the article of clothing was washed.

Turning now to FIGS. 2A and 2B, it is seen that indicator 12 is preferably a laminated double layer care label. The top layer, here designated by reference numeral 22, preferably bears conventional care instructions, such as DRY CLEAN ONLY. The top layer 22 is preferably manufactured of a non-woven fiber fabric wherein the fibers are held together by a water soluble adhesive. Although normal wearing, use and dry cleaning of the article of clothing does not affect layer 22, washing of the article of clothing in water causes the layer 22 to disintegrate, thus exposing an underlying layer, here designated by reference numeral 24, which may be printed with a non-water soluble legend, such as THIS GARMENT HAS BEEN WASHED IN WATER. Alternatively, layer 24 need not be provided and disintegration of layer 22 provides a sufficient indication that the article of clothing has been washed in water.

Turning now to FIGS. 3A and 3B, it is seen that indicator 14 is preferably a piece or portion of fabric 24 which has been impregnated with dye 26 microencapsulated by water soluble materials 28. Although normal wearing, use and dry cleaning of the article of clothing do not affect water soluble materials 28, washing of the article of clothing in water causes the materials 28 to dissolve, thus releasing the dye 26 and causing appearance of a visually sensible indication, which may be a written message, such as THIS GARMENT HAS BEEN WASHED IN WATER.

Turning now to FIGS. 4A and 4B, it is seen that indicator 16 is preferably an integral portion of the article of clothing which has been treated with a water responsive indicator so as to provide a visually sensible indication upon being washed in water. An example is a pocket liner 32, at least part of which has been impregnated with dye 36 microencapsulated by water soluble materials 38. Although normal wearing, use and dry cleaning of the article of clothing do not affect water soluble materials 38, washing of the article of clothing in water causes the materials 38 to dissolve, thus releasing the dye 36 and causing appearance of a visually sensible indication, which may be a written message, such as THIS GARMENT HAS BEEN WASHED IN WATER.

Reference is now made to FIGS. 5A and 5B, which illustrate another preferred embodiment of the present invention, wherein indicator 16, preferably an integral portion of the article of clothing, has been treated with a water responsive indication so as to provide a visually sensible indication upon being washed in water. An example is a pocket liner 42, at least a portion of which, such as indicator 16, has been treated so as to change color when washed in water. Although normal wearing, use and dry cleaning of the article of clothing do not affect indicator 16, washing of the article of clothing in water causes indicator 16 to change color, thus providing a visually sensible indication. FIG. 5A shows pocket liner before washing in water, where indicator 16 of pocket liner 42 is white, while FIG. 5B shows that indicator 16 of pocket liner 42, after being washed in water, has changed to black. It is appreciated that, even though the illustrated embodiment shows a change from white to black, that any colors may be used to show pre-washed and post-washed states of indicator 16.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. An article of clothing bearing an indicator which indicates whether it has been washed in water.

2. An article of clothing according to claim 1 and wherein said indicator comprises a label normally attached to said clothing.

3. An article of clothing according to claim 1 and wherein said indicator changes its state when it has been washed in water.

4. An article of clothing according to claim 1 and wherein said indicator includes at least one water soluble adhesive.

5. An article of clothing according to claim 1 and wherein said indicator disassociates as the result of prolonged exposure to water.

6. An article of clothing according to claim 1 and wherein said indicator includes a legend stating that it has been exposed to water and a water soluble cover, which covers said legend until said cover has been exposed to water.

7. An article of clothing according to claim 1 and wherein said indicator forms an integral part of said article of clothing.

8. An article of clothing according to claim 1 and wherein said indicator changes color as the result of washing in water.

9. An indicator useful with an article of clothing for indicating whether the article of clothing has been washed in water.
